(19) United States
(12) Patent Application Publication
(10) Pub. No.: US 2025/0101253 A1
(43) Pub. Date: Mar. 27, 2025

(54) UV-CURABLE COATING COMPOSITIONS

(71) Applicant: BASF COATINGS GMBH, Muenster (DE)

(72) Inventors: Susanne PIONTEK, Muenster (DE); Yannick PICHOT, Breuil le Sec (FR); Nicole STEGEMANN, Muenster (DE); Christian ARENS, Muenster (DE); Stefanie SCHWEINS, Muenster (DE); Lee Richard BURSTON, Muenster (DE)

(21) Appl. No.: 18/729,914

(22) PCT Filed: Feb. 15, 2023
(86) PCT No.: PCT/EP23/53731

§ 371 Date: Jul. 18, 2024

(30) Foreign Application Priority Data
Feb. 17, 2022 (EP) 22157294.4

(51) Int. Cl. C09D 175/02; C08F 290/06; C09D 5/00; C09D 7/20; C09D 7/48; C09D 7/80; C09D 151/00

(52) U.S. Cl. CPC C09D 175/02; C08F 290/067; C09D 7/20; C09D 7/48; C09D 151/003; C09D 5/002; C09D 7/80

(57) ABSTRACT

Disclosed herein is a UV curable coating composition including (A) a component A, comprising Aa) one or more resins, each of these resins having a hydroxyl number in a range of from 0 to 25 mg KOH/g; Ab) one or more UV reactive monomers including one or two (meth)acrylic groups; (B) a component B, including Ba) one or more isocyanate species; (C) a component C, including Ca) one or more aprotic organic solvents which do not react with any ingredient of the coating composition; and (D) a component D, including Da) one or more photoinitiators; at least one of Db) and/or Dc), Db) being one or more light stabilizers; and Dc) being one or more UV absorbers; wherein the total molar ratio of hydroxyl groups to free isocyanate groups in the UV curable coating composition is in a range from 0 to 1:5.

The present invention relates to UV-curable coating compositions, particularly UV-curable clearcoat compositions suitable as top coat compositions of multilayer coatings and a method to produce such coating compositions. The present invention further relates to a method of coating substrates, particularly coating pre-coated substrates, and the use of the coating compositions in refinish coating, particularly automotive repair coating.

### BACKGROUND

In the field of automotive coatings and similarly demanding fields, typically clearcoat compositions are applied to form clearcoat layers as uttermost layers (i.e., top coat layers) of a multilayer coating. Thus, there are high requirements of such layers particularly regarding appearance and gloss, weathering resistance, humidity resistance and mechanical properties such as scratch resistance. Particularly when used outdoors, many objects such as automotive vehicles are exposed to all kinds of weathering conditions such as sunlight, rain, high and low temperatures, snow and ice and have to endure many and even quick changes of such weathering conditions over their expected lifespan. Such conditions can cause severe mechanical stress to a multilayer coating. In particular the interlayer adhesion of the clear top coat layer to the subjacent layer such as a basecoat layer is likely to become a weak point.

Generally, clearcoat layers as topcoat layers in automotive coating are selected from so-called two-component systems (also known as two-pack systems) which often comprise hydroxy functional binders in one component and isocyanate crosslinkers in the other component. Both components are stored separately and only mixed right before use. Drying and curing times typically range from about one hour under IR-assisted drying to one day at room temperature. Typically, such two-component systems contain rather high amounts of solvents, which may cause environmental problems, and particularly in automotive refinish paint shop, problems with environmental regulations at the workplace.

Other attempts to create clear top coats involve the use of UV curable compositions, wherein at least a part, if not all organic solvents are replaced by so-called reactive diluents, i.e., solvents, which upon irradiation become part of the crosslinked network. A big advantage is the possibility of polishing the coating layer upon cure, which is particularly of big importance in refinish applications. While such UV curable coating compositions are established for primer fillers and the like, they are not yet fully established in the application of clearcoat layers.

One of the detrimental properties of such UV-curable coatings is the limited ability of UV-curable clearcoat layers to adhere to the subjacent basecoat layer under severe outdoor conditions over the live span of the coated substrates. Moreover, many UV-curable coating compositions require the rather high-energy radiation, such as UV-B and/or UV-C radiation to sufficiently cure, which requires higher safety measure under automotive repair conditions.

One drawback of solely UV-curable systems is that they are typically restricted to application on substrates having simple shapes, allowing the UV light to reach the whole surface of the coated substrate. Complex three-dimensional coated object may have shadow areas which are difficult to reach by the UV radiation.

In another attempt to provide clearcoats, particularly for automotive coatings the features of two-component systems were combined with those of UV-curable systems in so-called dual cure systems. In such dual cure systems both reaction types occur. Such compositions mostly contain isocyanate functional binders, hydroxy functional binders and UV-curable binders. However, it is even possible that UV-curable functional groups such as acrylate groups are present on the same binder which, e.g., carries the isocyanate groups or hydroxyl groups. While in shadow areas mostly thermal crosslinking between the hydroxy functional binder and the isocyanate functional binder (isocyanate functional crosslinker) occurs, rapid UV-curing is available for the other non-shadow regions of the coated substrate. Such dual cure systems, not restricted to the field of automotive coatings, are, e.g., described in EP 1 138 710 A1, EP 2 702 094, WO 2009/024310 A2, WO 2012/158630 and WO 99/55785 A1. Since one of the main crosslinking reactions in dual cure compositions is typically the reaction between isocyanate groups and hydroxyl groups, such compositions have a rather short pot-life, i.e., they have to be used immediately after mixing the hydroxyl group containing binder with the isocyanate functional crosslinker, which shortens the processing time. On the other hand, full cure of the systems requires either a longer timer or higher temperature, making it harder to use such composition in e.g., automotive repair coating. Particularly, polishing has to be postponed until sufficient cure is achieved. Moreover, such dual-cure compositions often require rather high proportions of volatile organic solvents to be applicable and may thus create environmental problems, particularly for small automobile coating shops.

Having the above drawbacks of the state of the art in mind, it was the aim of the present invention to provide UV-curable coating compositions, which fully cure at ambient temperature (25° C.) in a very short time, even with low energy UV radiation such as UV radiation in the UV-A wavelength range, having a rather high pot life upon mixing all ingredients, being in the range of up to two days. Furthermore, the crosslinking of the coating compositions should mainly rely on the mechanism of UV crosslinking. The thus coated and cured coating layers should show a good polishability immediately after UV curing as well as good weathering resistance, particularly under the severe conditions of the well-established Weather-Ometer® CAM 180 test as described in the experimental section of the present invention, which satisfies the standards of ISO 11341 and ISO 11507. A particular aim of the present invention was to provide an improved interlayer adhesion of the coating compositions of the present invention, particularly the clearcoat compositions of the present invention to subjacent coating layers, particularly basecoat layers such as basecoat layers formed from aqueous or solvent-borne basecoat compositions, preferably physically drying aqueous or solvent-borne basecoat compositions, and even more preferred aqueous physically drying basecoat compositions, when compared to conventional UV curable coating compositions.

### SUMMARY

The aims of the present invention were achieved by providing a UV curable coating composition comprising
A) a component A, comprising
   Aa) one or more resins
      i. each of these resins having a hydroxyl number in the range of 0 to 25 mg KOH/g;
      ii. each of these resins having a (meth)acrylic group functionality of at least 1.5; and
      iii. the total of these resins having in sum on average a (meth)acrylic group functionality of 2.0 to 4.0;
   Ab) one or more UV reactive monomers comprising one or two (meth)acrylic groups;
B) a component B, comprising
   Ba) one or more isocyanate species containing one or more groups selected from the group consisting of allophanate groups, biuret groups, uretdione groups, urethane groups, iminooxadiazindione groups and isocyanurate groups; and each isocyanate species comprising on average at least one isocyanate group and at least one (meth)acrylate group;
C) a component C, comprising
   Ca) one or more aprotic organic solvents which do not react with any of the other ingredients comprised in the UV-curable coating composition; and
D) a component D, comprising
   Da) one or more photoinitiators; and at least one of Db) and/or Dc)
   Db) being one or more light stabilizers; and
   Dc) being one or more UV absorbers;
wherein the total molar ratio of hydroxyl groups to free isocyanate groups in the UV curable coating composition is in the range from 0 to 1:5.

The term “UV curable” as used herein refers to a coating composition which cures upon irradiation with UV light, herein most preferred UV light in the UV-A region of the spectrum.

The term “resin” as used herein has the well-established meaning known to one of skill in the art of coatings. This term encompasses oligomers and polymers likewise.

The term “(meth)acrylic” or “(meth)acrylate” as used herein encompasses acrylic and methacrylic, as well as acrylate and methacrylate, respectively.

The term “species” as used in “isocyanate species” refers to substances which can comprise discrete molecule having a definite molecular weight, but also oligomers and polymers.

The afore-mentioned composition and its preferred embodiments as described herein-after are also denoted as “coating compositions according to the invention” or “compositions according to the invention”.

A further subject of the present invention is a method of preparing the coating composition according to the invention, the method comprising the steps of
a. mixing one or more of the Ca) aprotic organic solvents, which do not react with any of the other ingredients comprised in the UV-curable coating composition of the present invention, with one or more of the other ingredients and/or components of the UV-curable coating composition of the present invention to form one or more dispersions or solutions of these ingredients and/or components;
b. subsequently mixing all dispersions and/or solutions obtained in step a. with any further ingredients and/or components of the coating composition of the present invention, except for component B or the dispersion or solution of component B with one or more of the Ca) aprotic organic solvents to thus form a master batch; and
c. subsequently mixing the master batch with component B and/or the dispersion or solution of component B with one or more of the Ca) aprotic organic solvents.

The afore-mentioned method and its preferred embodiments as described herein-after are also denoted as “methods of preparing a coating composition according to the invention” or “preparation methods according to the invention”.

Yet another subject of the present invention is a method of coating a substrate with the coating composition of the present invention, comprising the steps of
i.) applying the coating composition according to the present invention at least partially onto at least one surface of an optionally pre-coated substrate to form a coating layer on the surface of the substrate; and subsequently
ii.) curing the coating layer obtained in step i.) by UV curing to form a cured coating layer on the surface of the substrate.

The afore-mentioned method and its preferred embodiments as described herein-after are also denoted as “methods of coating a substrate according to the invention” or “coating methods according to the invention”.

Further subject of the invention is the use of the coating compositions of the invention in refinish coating applications as top coat coating composition.

The afore-mentioned use is also denoted as “use according to the invention”.

### DETAILED DESCRIPTION

If reference is made in the context of the present invention to an (official) standard, this denotes the version of the standard that was most recent on the filing date, or, if no current version exists at that date, the last current version, unless stated otherwise.

### UV Curable Coating Composition

The UV curable coating compositions of the present invention comprise, and preferably consist of the components A, B, C, D and optionally E as defined below. Particularly preferred the UV curable coating compositions of the present invention comprise, and preferably consist of the component A, comprising or preferably consisting of Aa) and Ab); component B, comprising or preferably consisting of Ba) and optionally Bb); component C, comprising or preferably consisting of Ca); component D comprising or preferably consisting of Da) and at least one or Db) and Dc); and component E, comprising and preferably consisting of Ea) and optionally Eb) and/or optionally Ec) as defined below.

### Component A

### The Aa) One or More Resins as Specified Above

Component A comprises Aa) one or more resins each of these resins having a hydroxyl number in the range of 0 to 25, preferably from 0 to 20 mg KOH/g, more preferred from 0 to 15 mg KOH/g such as 1, 2, 3 or 4 to 15 mg KOH/g. It is crucial for the purposes of the present invention that the hydroxyl number is below 25 mg KOH/g, because it is not intended that the Aa) one or more resins significantly contribute to a hydroxyl/isocyanate crosslinking with the isocyanate species of component B. One of skill in the art is aware that for the very same reason component A, particularly the one or more resins Aa) and the one or more UV reactive monomers Ab) should not contain NCO groups.

The main crosslinking reaction taking place in the UV curable coating composition should be crosslinking between (meth)acrylic groups, which are present in Components A and B, while the isocyanate groups being present in Component B should be in large excess compared to the very low content of hydroxyl groups in Component A. The hydroxyl value of component A is preferably in the same range as described above for the one or more resins Aa) of component A.

Thus, the properties of the network created upon UV curing of the coating layer should mainly be the result of crosslinking between (meth)acrylic groups.

For this reason, each of these Aa) one or more resins have a (meth)acrylic group functionality of at least 1.5, preferably at least 1.8 and most preferably at least 2.0; as preferably from 2.0 to 6.0, more preferred 2.0 to 4.0, even more preferred 2.0 to 3.5, most preferred 2.0 to 3.0 such as 2.2 to 2.8; and the total of these Aa) resins having in sum on average a (meth)acrylic group functionality of 2.0 to 4.0, preferably 2.1 to 3.5, more preferred 2.2 to 3.0 and most preferred 2.3 to 2.8.

It is evident that the higher the (meth)acrylic group functionality, the higher the crosslinking density and the harder the resulting coating, while this goes along with good scratch resistance and chemical resistance as well as the ability to be polishable directly after applying the crosslinking UV radiation. It was also found that this is on the cost of flexibility, which, particularly after a severe weathering test—as applied herein—leads to cracks in the coating.

Furthermore, it is to be considered that the main application field of the coating compositions according to the present invention is their use in the formation of clearcoat layers. Particularly those coating compositions, which are applied in refinish applications, such as automotive repair applications, need to strongly adhere on the subjacent basecoat layer, particularly to those basecoat layers being formed from aqueous basecoat compositions, even more particularly those formed from aqueous physically drying basecoat compositions, which form rather soft basecoat layers.

Moreover, in refinish applications the clearcoat layer does not only need to adhere to the subjacent basecoat, but also needs to be compatible with the OEM clear coat layer, which is typically based on hydroxyl-isocyanate crosslinking chemistry. In case the differences in hardness and flexibility, respectively, between the coating layer of the present invention, the subjacent basecoat layer and the OEM clear coat layer are too big, cracks will occur. This aspect is particularly true, for the repair region of the coating layer obtained from the coating composition according to the present invention, where it merges into the conventional clear coat from the OEM coating. This region is typically treated with a so-called blender before UV-curing the coating composition of the present invention to merge both areas.

Contrary to other approaches as, e.g., WO 2014/012852 A1, where two multifunctional (meth)acrylates with very high functionalities of at least 4 and at least 5, are to be used, the present invention makes use of low functionality resins. Laromer® UA 9050, as used in WO 2014/012852 A1 being an aliphatic urethane (meth)acrylate and having a (meth)acrylic group functionality of 8.3. Although the resulting coating (Example 11 of WO 2014/012852 A1) showed flexibility without cracking in a very simple non-weathering flexibility testing, wherein a coated plastic plate was just bent over a pipe with a diameter of 9 cm, with the uncoated reverse in contact with the pipe, adherence to the basecoat layer after severe weathering conditions still needed to be improved.

The above-mentioned Aa) one or more resins may be selected from the group consisting of aliphatic or aromatic resins and are preferably selected from the group of aliphatic resins. Particularly in view of weathering resistance, it was found that urethane (meth)acrylates, polyester (meth)acrylates and urethane group containing (meth)acrylic resins are preferred, the latter ones are also known as urethane-modified (meth)acrylic resins or sometimes even subsumed under the term urethane (meth)acrylates. Most preferred are urethane (meth)acrylates and urethane group containing (meth)acrylic resins, since for most polyester (meth)acrylates the hydroxyl number is too high.

Preferably the Aa) one or more resins have a number-average molecular weight in the range from 400 g/mol to 3500 g/mol, more preferred in the range from 500 g/mol to 3000 g/mol, even more preferred in the range from 600 g/mol to 2500 g/mol and most preferred in the range from 700 g/mol to 2000 mg/mol. The number-average molecular weights can be determined by gel permeation chromatography as described in detail in the experimental section of the present invention.

Generally, the higher the number-average molecular weight, the higher the viscosity of the resins and thus the higher the amount of the Ab) one or more UV reactive monomers comprising one or two (meth)acrylic groups and/or the Ca) one or more aprotic organic solvents, required to obtain a suitable viscosity for spray application, which is the application method of choice in refinish application, particularly automotive repair coating.

Amongst all of the afore-mentioned Aa) resins, the resins having an acrylic group are preferred over the ones having a methacrylic groups, because of the higher reactivity or acrylic groups.

Such Aa) resins can be easily manufactured from oligomeric or polymeric polyols, such as polyether polyols or polyester polyols by, e.g., reacting at least part of the hydroxyl groups with a (meth)acrylic monomer having reactive groups which can react with hydroxyl groups of the afore-mentioned polyether polyols or polyester polyols, thus reducing their hydroxyl number and introducing (meth)acrylic functional groups. If such polyether polyol or polyester polyol is, e.g., started with a di- or trihydroxy functional core monomer to which linear chains with terminal hydroxyl groups are attached, e.g., by addition of alkylene oxides in case of polyether polyols or, e.g., by ring-opening addition of lactones in case of polyester polyols, it is possible to produce oligomers or polymers having an exact number of terminal hydroxyl groups. If all terminal hydroxyl groups are consumed by reaction with a (meth)acrylic monomer having a reactive group which can react with hydroxyl groups, such resulting resin will also contain said exact functionality with respect to (meth)acrylic functional groups. Consequently, it is possible to synthesize resins which are exactly di- or trifunctional, or having higher functionalities, depending on the reactants employed in their manufacture.

Most preferred as the Aa) one or more resins are urethane (meth)acrylate resins. Such resins are, e.g., available as aliphatic urethane (meth)acrylate resins from BASF SE under the tradenames Laromer® UA 19T, Laromer® UA 8987 N, Laromer® UA 9029, Laromer® UA 9030, Laromer® UA 9033 N, Laromer® UA 9072, and Laromer® UA 9089, all of which have on average 2 to 2.9 (meth)acrylic groups and hydroxyl numbers in the range from 3 to 12 mg KOH/g. An example of an aromatic urethane (meth)acrylate resin, and thus a less preferred resin, is, e.g., Laromer® UA 9073 which is also commercially available from BASF SE, and has a (meth)acrylic group functionality of 2 and a hydroxyl number of 9 mg KOH/g. Similar products are commercially available under the tradename Ebecryl® from Allnex and Sartomer® from Sartomer/Arkema.

### Ab) UV Reactive Monomers Comprising One or Two (Meth)Acrylic Groups

Component A comprises Ab) one or more, for example one to four, preferably one to three, more preferably one or two UV reactive monomers comprising one or two (meth)acrylic groups. The UV reactive monomers may by aliphatic or aromatic monomers and the aliphatic monomers may contain—besides the obligatory (meth)acrylic groups—one or more further unsaturated groups and/or hetero atoms. However, they do preferably not contain functional groups which are reactive with isocyanate groups. Thus, they preferably do not contain hydroxyl groups.

The Ab) one or more UV reactive monomers comprising one (meth)acrylic group may contain aromatic groups, as e.g., phenoxyethyl (meth)acrylate; they may also contain heteroatoms such as, e.g., in trimethylolpropane formal mono(meth)acrylate, or may contain further unsaturated groups such as, e.g., in dicyclopentenyl (meth)acrylate.

Further preferred UV reactive monomers comprising one (meth)acrylic group are the mono(meth)acrylic esters of alkane mono alcohols, dialkylene glycol monoalcohols and trialkylene glycol monoalcohols, wherein the alkane mono alcohols preferably contain from 2 to 20, more preferred 4 to 16 carbon atoms; and glycols in the dialkylene glycol monoalcohols and triethylene glycol monoalcohols are either ethylene glycol or propylene glycol or both. Examples of preferred mono(meth)acrylic esters of alkane mono alcohols are 2-ethylhexyl (meth)acrylate, isodecyl (meth)acrylate, lauryl (meth)acrylate and isobornyl (meth)acrylate. Most preferred amongst the UV reactive monomers comprising one (meth)acrylic group are trimethylolpropane formal mono(meth)acrylate and the mono(meth)acrylic esters of alkane mono alcohols with 6 to 12 carbon atoms.

The Ab) one or more UV reactive monomers comprising two (meth)acrylic groups are preferably the di(meth)acrylic esters of alkane diols, dialkylene glycols and trialkylene glycols, wherein the alkane diols preferably contain from 2 to 12 carbon atoms and the alkylene glycols in the dialkylene glycols and trialkylene glycols are ethylene glycol and/or propylene glycol. Examples of preferred mono(meth)acrylic esters of alkane mono alcohols are hexanediol di(meth)acrylate, dipropylene glycol di(meth)acrylate and tripropylene glycol di(meth)acrylate.

Amongst all of the afore-mentioned Ab) UV reactive monomers the acrylates are preferred over the methacrylates, because of their higher reactivity; and further the aliphatic UV reactive monomers are preferred over the aromatic UV reactive monomers.

The Ab) UV reactive monomers act as reactive thinners (also called “reactive diluents”), i.e., as solvents which typically reduce the viscosity of the composition, and become part of the cured network by being incorporated by reaction into the network. Herein, the Ab) UV reactive monomers do preferably not contain any groups which are reactive towards isocyanate groups.

Contrary to the Aa) one or more resins as described above, the Ab) UV reactive monomers have distinct molecular weight and are thus not considered as oligomers or polymers, since oligomers and polymers typically possess a polydispersity, i.e., they have different number-average and weight-average molecular weights.

The coating compositions of the present invention preferably contain at least one Ab) UV reactive monomer having one (meth)acrylic groups and at least one having two (meth)acrylic groups.

Preferably component A consists of the Aa) one or more resins as described above, and the Ab) UV reactive monomers as described above.

### Component B

### Ba) Isocyanate Species as Specified Above

Component B comprises Ba) at least one, for example one to two, or two or more, preferably one isocyanate species selected from the group consisting of allophanates, biurets, uretdiones, iminooxadiazindiones and isocyanurates, having at least one free isocyanate group and at least one (meth)acrylate group.

Each isocyanate species contained in component B has at least one, preferably at least two free isocyanate groups. The free NCO content (calculated as 42 g/mol) of the Ba) one or more isocyanate species of component B should be at least 8% by weight, preferably from 10 to 25, more preferably from 12 to 23 and most preferably from 14 to 16% by weight.

The viscosity of component B and each of the Ba) one or more isocyanate species of component B (according to DIN EN ISO 3219 (shear rate D, 100 s⁻¹ at 23° C.) is preferably 200 to 10000 mPas, particularly preferably 400 to 5000 and very particularly preferably 1000 to 2000 mPas.

The number average molecular weight of each of the Ba) one or more isocyanate species contained in component B is preferably from 300 to 2500 g/mol, more preferably 400 to 2000 and most preferably from 450 to 1500 g/mol.

The Ba) one or more isocyanate species of component B have on average at least one, preferably one to three, more preferably at least two (meth)acrylate groups.

Most preferably the Ba) one or more isocyanate species of component B, each on average have 2 to 3, preferably 2 free NCO groups and 2 to 3, preferably 2 (meth)acrylate groups.

It is assumed that the presence of the Ba) one or more isocyanate species containing one or more groups selected from the group consisting of allophanate groups, biuret groups, uretdione groups, urethane groups, iminooxadiazindione groups and isocyanurate groups, each isocyanate having at least one free isocyanate group and at least one (meth)acrylate group strongly contribute to the improved adhesion of the coating layer formed from the coating composition according to the present invention to the subjacent coating layer, such as a basecoat layer, in that the free isocyanate groups bind to hydroxyl groups present on the surface of such subjacent coating layer, while the at least one (meth)acrylate groups is incorporated into the UV radiation cured network formed in the coating layer obtained by the coating composition of the present invention.

Preferably the Ba) one or more isocyanate species, as defined above, are reaction product of
at least one polyisocyanates P, preferably an aliphatic polyisocyanate, preferably an aliphatic diisocyanate
with at least one compound R having at least one isocyanate-reactive group and at least one (meth)acrylate group; and
optionally, but not preferred, with at least one compound CE having at least two isocyanate-reactive groups.

The term “aliphatic” as used herein and defined by IUPAC includes acyclic or cyclic, saturated or unsaturated carbon containing compounds or residues, excluding aromatic compounds or residues.

Herein, aliphatic compounds are preferably saturated aliphatic compounds.

### Polyisocyanates P

Herein below, the polyisocyanates P, which are preferably used in the manufacture of the Ba) one or more isocyanate species of component B are described.

The term “polyisocyanate” as used herein encompasses all isocyanates having 1.5 or more free isocyanate groups, such as up to 5, preferably up to 4, more preferred up to 3 free isocyanate groups, while a “diisocyanate” is encompassed by the term “polyisocyanate”, but has on average just at least 1.5 up to less than 2.5 free isocyanate groups.

Aromatic polyisocyanates are preferably aromatic diisocyanates having a divalent hydrocarbon residue between the two isocyanate groups, the divalent hydrocarbon residue being aromatic and containing 6 to 20, more preferred 7 to 16, even more preferred 7 to 14 carbon atoms.

The aliphatic polyisocyanates, which are preferred herein, are preferably saturated aliphatic diisocyanates having a divalent hydrocarbon residue between the two isocyanate groups, the divalent hydrocarbon residue containing 4 to 20, more preferred 4 to 16, even more preferred 4 to 12 and most preferred 6 to 10 carbon atoms.

Examples of customary aliphatic diisocyanates are acyclic diisocyanates, such as tetramethylene diisocyanate, 1,6-hexamethylene diisocyanate (1,6-diisocyanatohexane), octamethylene diisocyanate, decamethylene diisocyanate, dodecamethylene diisocyanate, tetradecamethylene diisocyanate, derivatives of lysindiisocyanate, tetramethylxylylene diisocyanate, trimethylhexane diisocyanate or tetramethylhexane diisocyanate; cycloaliphatic diisocyanates such as 1,4-, 1,3- or 1,2-diisocyanatocyclohexane, 4,4′- or 2,4′-di (isocyanatocyclohexyl) methane, 1-isocyanato-3,3,5-trimethyl-5-(isocyanatomethyl) cyclohexane (isophorone diisocyanate), 1,3- or 1,4-bis(isocyanatomethyl) cyclohexane or 2,4- or 2,6-diisocyanato-1-methylcyclohexane. Most preferred are 1,3-bis(isocyanatomethyl) cyclohexane, di(isocyanatocyclohexyl) methane, 1,6-hexamethylene diisocyanate and isophorone diisocyanate, amongst which isophorone diisocyanate and 1,6-hexamethylene diisocyanate, particularly the latter one is even more preferred.

Of course, mixtures of diisocyanates, such as the afore-mentioned diisocyanates may also be used.

As polyisocyanates any dimerization or trimerization products of the afore-mentioned diisocyanates may be employed in the manufacture of the Ba) one or more isocyanate species of component B. Such dimerization and/or trimerization products of the afore-mentioned diisocyanates may already contain one or more groups selected from allophanate groups, biuret groups, uretdione groups, urethane groups, iminooxadiazindione groups and isocyanurate groups. Some of the groups, such as allophanate groups and urethane groups may be formed by oligomerization of the diisocyanates in the presence of hydroxyl functional compounds or water in case of biuret groups.

Any of the polyisocyanates can be used in mixture with other polyisocyanates and/or diisocyanates.

Compound R with an Isocyanate-Reactive Group and a (Meth)Acrylate Group

Herein below, compounds R, which are preferably used in the manufacture of the Ba) one or more isocyanate species of component B, are described.

Compounds R are those which carry at least one isocyanate-reactive group and at least one (meth)acrylate group. With these compounds the one or more (meth)acrylate groups are introduced into the Ba) one or more isocyanate species of component B by reaction between at least one of the isocyanate groups of the polyisocyanates P and the isocyanate-reactive group(s) of compounds R.

Preferably, the compound R is a compound having exactly one isocyanate-reactive group and one (meth)acrylate group. Compounds R are preferably monomers preferably having a molecular weight below 500 g/mol, even more preferred below 300 g/mol.

Isocyanate-reactive groups are preferably selected from the group consisting of hydroxyl groups, thiol groups, primary and secondary amino group.

Preferred examples of compounds R are the monoesters of (meth)acrylic acid with diols or which preferably comprise 2 to 20 carbon atoms, such as ethylene glycol, diethylene glycol, triethylene glycol, tetraethylene glycol, pentaethylene glycol, 1,2-propylene glycol, 1,3-propylene glycol, 1,1-dimethyl-1,2-ethanediol, dipropylene glycol, tripropylene glycol, 1,2-, 1,3- or 1,4-butanediol, 1,5-pentanediol, neopentyl glycol, 1,6-hexanediol, 2-methyl-1,5-pentanediol, 2-ethyl-1,4-butanediol, 1,4-dimethylolcyclohexane, 2,2-bis(4-hydroxycyclohexyl) propane. Amides of (meth)acrylic acid with amino alcohols may also be used, e.g., 2-aminoethanol, 2-(methylamino) ethanol, 3-amino-1-propanol, 1-amino-2-propanol or 2-(2-aminoethoxy) ethanol, such as ethylenediamine or diethylenetriamine.

Preference is given to using hydroxyalkyl (meth)acrylates, such as 2-hydroxyethyl (meth)acrylate, 2- or 3-hydroxypropyl (meth)acrylate, 4-hydroxybutyl (meth)acrylate, neopentyl glycol mono(meth)acrylate, 5-hydroxypentyl (meth)acrylate, 6-hydroxyhexyl (meth)acrylate,

### Compound CE Having at Least Two Isocyanate-Reactive Groups

Herein below, exemplary compounds CE, which might be used in the manufacture of the Ba) one or more isocyanate species of component B are described. However, the use of such compounds in the manufacture of the Ba) one or more isocyanate species of component B is not preferred.

If used, compounds CE are preferably linear, branched or cyclic alkane diols, the alkane in the alkane diol having 2 to 20 carbon atoms, preferably 2 to 10 carbon atoms.

Most preferably, the Ba) one or more isocyanate species contained in component B are manufactured by reacting one or more aliphatic polyisocyanates P, even more preferred aliphatic diisocyanates, most preferred hexamethylene-1,6-diisocyanate and/or isophorone diisocyanate with one or more hydroxyalkyl (meth)acrylates, even more preferred hydroxyalkyl (meth)acrylates, most preferred hydroxyethyl (meth)acrylate and/or hydroxypropyl (meth)acrylate. Amongst the afore-mentioned reaction products those are preferred, which have on average have 2 to 3, preferably 2 free NCO groups and 2 to 3, preferably 2 (meth)acrylate groups. Amongst the (meth)acrylates, the acrylates being preferred, again.

Most preferred, the Ba) one or more isocyanate species contained in component B contain allophanate groups and having the following formula (I)

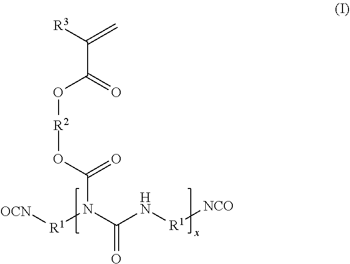

wherein
R¹ is a divalent linear or branched or cyclic alkylene radical which preferably has 2 to 20 carbon atoms, more preferred 2 to 12, even more preferred 4 to 10 and most preferred 4 or 8 carbon atoms, and particularly preferred 6 carbon atoms;
R² is a divalent branched or linear alkylene radical which preferably has 2 to 10 carbon atoms, more preferred 2 to 8, even more preferred 2 to 4 and most preferred 2 or 3 carbon atoms; and particularly preferred an ethylene radical;
R³ is H or methyl, most preferred H; and
x is a positive number being on average more than 1 up to 4, more preferred 2 to 3, most preferred 2.

Such products are commercially available, for example, under the trade name Laromer® PR 9000 from BASF SE, Ludwigshafen, having on average 2 (meth)acrylic functional groups and 2 NCO groups (14 to 15 wt.-% NCO groups).

Other suitable Ba) isocyanate species are, e.g., aliphatic isocyanate functional urethane acrylates available under the tradenames Ebecryl® 4150 having on average 1 (meth)acrylic functional group and 2 NCO groups (approx. 13 wt.-% NCO groups), Ebecryl® 4397 having on average 1 (meth)acrylic functional groups and 3 NCO groups (approx. 6.7 wt.-% NCO groups) Ebecryl® 4510 having on average 1.5 (meth)acrylic functional group and 1.5 NCO groups (approx. 7 wt.-% NCO groups), Ebecryl® 4141 having on average 2 (meth)acrylic functional groups and 2 NCO groups (approx. 12 wt.-% NCO groups), Ebecryl® 4765 having on average 2 (meth)acrylic functional groups and 2.5 NCO groups (approx. 4.5 wt.-% NCO groups), Ebecryl® 4250 having on average 3.4 (meth)acrylic functional groups and 1.4 NCO groups (approx. 5 wt.-% NCO groups), all of the afore-mentioned products being available from Allnex.

Bb) Polyisocyanates with No (Meth)Acrylic Group

Due to the manufacturing process of the Ba) isocyanate species as described above, sometimes by-products containing no (meth)acrylic groups in the species are present in the reaction mixture, such as oligomers or polymers of the polyisocyanates or diisocyanates used in the manufacture of Ba). Thus, such products, even the commercially available ones may contain varying contents of, e.g., homopolymers of diisocyanates such as hexamethylene diisocyanate homopolymers. Furthermore, it cannot be excluded that low amounts of starting products, such as diisocyanate monomers are contained in such reaction products.

If the Bb) polyisocyanates with no (meth)acrylic groups are polymers, their content based on the combined weight of the Ba) one or more isocyanate species as defined above and the Bb) polyisocyanates with no or less than one (meth)acrylic groups, should preferably be less than 15 wt.-%, more preferred less than 10 wt.-% and even more preferred 0 to 5 wt.-%.

If the Bb) polyisocyanates with no (meth)acrylic groups are monomers, their content based on the combined weight of the Ba) one or more isocyanate species as defined above and the Bb) polyisocyanates with no or less than one (meth)acrylic groups, should preferably be less than 5 wt.-%, more preferred less than 2 wt.-% and even more preferred less than 1 wt.-%, such as 0 to 0.5 wt.-%.

### Component C

### Ca) Aprotic Organic Solvents

The one or more aprotic organic solvents of component C, which do not react with any of the other ingredients comprised in the coating composition, particularly which do not react with any of components A, B and D, or the optionally contained component E, may be polar or non-polar solvents. The requirement “not to react with the components A and B” clearly distinguishes the solvents of component C from the one or more UV reactive monomers comprising one or two (meth)acrylic groups (also called “reactive diluents”) as present in component A. This also means that the aprotic organic solvents of component C have no UV curable groups, no groups which are reactive towards hydroxyl groups and no groups which are reactive towards isocyanate groups.

One main aspect is to preferably select the aprotic organic solvent amongst those having a high evaporation rate at room temperature, thus, allowing the organic solvent to evaporate from the coating film in a very short time (“flash-off”) after application of the coating composition to the substrate, such as a substrate with a basecoat layer on top.

The aprotic organic solvents may be non-polar, such as Solvent Naphtha, however, they are preferably polar aprotic solvent, preferably selected from the group consisting of esters and ketones. Suitable ketones are, e.g., methyl isobutyl ketone, methyl ethyl ketone, diethyl ketone, tert.-butyl methyl ketone, methyl isoamyl ketone and acetone, while suitable esters are, e.g., ethyl acetate, 1-methoxypropylacetate-2,2-methoxyethyl acetate and butyl acetate. It is also possible and preferred to use mixtures of such solvents, e.g., mixtures of esters with ketones.

Most preferably, the Ca) aprotic organic solvents are inert, i.e., they do not react with any of the other components or ingredients under curing conditions.

### Component D

The coating compositions according to the present invention contain Da) one or more photoinitiators, and at least one of Db) and Dc); Db) being one or more light stabilizers and Dc) being one or more UV absorbers.

### Da) Photoinitiators

As photoinitiators it is possible to use photoinitiators known to the skilled person, examples being those stated in “Advances in Polymer Science”, Volume 14, Springer Berlin 1974 or in K. K. Dietliker, Chemistry and Technology of UV- and EB-Formulation for Coatings, Inks and Paints, Volume 3; Photoinitiators for Free Radical and Cationic Polymerization, P. K. T. Oldring (ed.), SITA Technology Ltd, London.

Examples of those contemplated include phosphine oxides, benzophenones, a-hydroxyalkyl aryl ketones, thioxanthones, anthraquinones, acetophenones, benzoins and benzoin ethers, ketals, imidazoles, phenylglyoxylic acids and phenylglyoxylates, the latter ones being most preferred.

Photoinitiators contemplated are those as described in WO 2006/005491 A1, page 21, line 18 to page 22, line 2 (corresponding to US 2006/0009589 A1, paragraph [0150]), hereby made part of the present disclosure by reference.

The following compounds may be cited as examples of the individual classes.

Mono- or bisacylphosphine oxides, such as Irgacure® 819 (bis(2,4,6-trimethylbenzoyl)phenyl-phosphine oxide), of the kind described for example in EP-A 7 508, EP-A 57 474, DE-A 196 18 720, EP-A 495 751, or EP-A 615 980, examples being 2,4,6-trimethylbenzoyldiphenylphosphine oxide (Lucirin® TPO), ethyl 2,4,6-trimethylbenzoylphenylphosphinate, and bis(2,6-dimethoxybenzoyl)-2,4,4-trimethylpentylphosphine oxide;
benzophenone and its derivatives, such as 4-aminobenzophenone, 4,4′-bis(dimethylamino) benzophenone, 4-phenylbenzo-phenone, 4-chlorobenzophenone, Michler's ketone, o-methoxybenzophenone, 2,4,6-trimethylbenzophenone, 4-methylbenzophenone, 2,4-dimethyl-benzophenone, 4-isopropylbenzophenone, 2-chlorobenzophenone, 2,2′-dichlorobenzo-phenone, 4-methoxybenzophenone, 4-propoxybenzophenone, or 4-butoxybenzophenone; 1-Benzoylcyclohexan-1-ol (1-hydroxycyclohexyl phenyl ketone), 2-hydroxy-2,2-dimethylaceto-phenone (2-hydroxy-2-methyl-1-phenylpropan-1-one), 1-hydroxyacetophenone, 1-[4-(2-hydroxyethoxy)phenyl]-2-hydroxy-2-methyl-1-propan-1-one, polymer comprising in copolymerized form 2-hydroxy-2-methyl-1-(4-isopropen-2-ylphenyl) propan-1-one (Esacure® KIP 150);
10-thioxanthenone, thioxanthen-9-one, xanthen-9-one, 2,4-dimethylthioxanthone, 2,4-diethyl-thioxanthone, 2,4-diisopropylthioxanthone, 2,4-dichlorothioxanthone, and chloroxanthenone; β-methylanthraquinone, tert-butylanthraquinone, anthraquinonecarbonyl acid esters, benz-[de]anthracen-7-one, benz [a]anthracene-7,12-dione, 2-methylanthraquinone, 2-ethyl-anthraquinone, 2-tert-butylanthraquinone, 1-chloroanthraquinone, 2-amylanthraquinone; acetophenone, acetonaphthoquinone, valerophenone, hexanophenone, α-phenylbutyro-phenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-tri-acetylbenzene, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one, 2-benzyl-2-dimethylamino-1-(4-morpholinophenyl)-butan-1-one;
4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether, and 7-H-benzoin methyl ether;
acetophenone dimethyl ketal, 2,2-diethoxyacetophenone, and benzil ketals, such as benzil dimethyl ketal;
phenylglyoxalic acids and phenylglyoxalates as described in DE-A 198 26 712, DE-A 199 13 353, or WO 98/33761, examples being phenylglyoxalic acid monoesters and diesters with polyethylene glycols having a molar mass of 62 to 500 g/mol and those which are present in Omnirad® 754;
benzaldehyde, methyl ethyl ketone, 1-naphthaldehyde, triphenylphosphine, tri-o-tolylphosphine, and 2,3-butanedione.

Particularly noteworthy mixtures are 2-hydroxy-2-methyl-1-phenylpropan-2-one and 1-hydroxy-cyclohexyl phenyl ketone; bis(2,6-dimethoxybenzoyl)-2,4,4-trimethylpentylphosphine oxide and 2-hydroxy-2-methyl-1-phenylpropan-1-one; benzophenone and 1-hydroxycyclohexyl phenyl ketone; bis(2,6-dimethoxybenzoyl)-2,4,4-trimethylpentylphosphine oxide and 1-hydroxycyclohexyl phenyl ketone; 2,4,6-trimethylbenzoyldiphenylphosphine oxide and 2-hydroxy-2-methyl-1-phenylpropan-1-one; 2,4,6-trimethylbenzophenone and 4-methylbenzophenone; 2,4,6-trimethylbenzophenone and 4-methylbenzophenone and 2,4,6-trimethylbenzoyldiphenylphosphine oxide; and particularly preferred oxy-phenyl-acetic acid 2-[2-oxo-2-phenyl-acetoxy-ethoxy]-ethyl ester and oxy-phenyl-acetic acid 2-[2-hydroxyethoxy]-ethyl ester (Omnirad® 754).

Likewise conceivable as photoinitiators are polymeric photoinitiators such as, for example, the diester of carboxymethoxybenzophenone with polytetramethylene glycols of various molar weights, specifically 200 to 250 g/mol (CAS 515136-48-8), and also CAS 1246194-73-9, CAS 813452-37-8, CAS 71512-90-8, CAS 886463-10-1, or other polymeric benzophenone derivatives, of the kind available commercially, for example, under the trade name Omnipol® BP from IGM Resins B. V., Waalwijk, The Netherlands or Genopol® BP1 from Rahn AG, Switzerland. Also conceivable, furthermore, are polymeric thioxanthones, an example being the diester of carboxymethoxythioxanthones with polytetramethylene glycols of various molar weights, of the kind available commercially, for example, under the trade name Omnipol® TX from IGM Resins B. V., Waalwijk, The Netherlands. Also conceivable, moreover, are polymeric a-amino ketones, as for example the diester of carboxyethoxythioxanthones with polyethylene glycols of various molar weights, of the kind available commercially, for example, under the trade name Omnipol® 910 or Omnipol® 9210 from IGM Resins B. V., Waalwijk, The Netherlands.

Further suitable photoinitiators are, e.g., silsesquioxane compounds having at least one initiating group, of the kind described in WO 2010/063612 A1, particularly from page 2, line 21 to page 43, line 9 therein, as is hereby made part of the present disclosure by reference, specifically from page 2, line 21 to page 30, line 5, and also the compounds described in the examples of WO 2010/063612 A1.

Amongst all of the above-mentioned photoinitiators those are particularly preferred, which are apt to initiate UV-curing of the UV curable coating compositions of the present invention in the UV-A range, i.e. in the wavelength range from 315 to 400 nm, preferably 315 nm to 395 nm or 315 to 385 nm.

### Db) Light Stabilizers

Light stabilizers can be used alone or together with suitable radical scavengers. Preferred light stabilizers in the present invention are sterically hindered amin light stabilizers (HALS). The transformation of HALS to nitroxy radicals is slower than the photoinitiating step, thus they to not interfere with free radical polymerization. Examples for HALS being amines such as 2,2,6,6-tetramethylpiperidine, 1,2,2,6,6-pentamethylpiperidine 2,6-di-tert-butylpiperidine, or derivatives thereof, such as bis(2,2,6,6-tetramethyl-4-piperidyl) sebacate, bis(1,2,2,6,6-pentamethyl-4-piperidyl) sebacate, and methyl-(1,2,2,6,6-pentamethyl-4-piperidyl) sebacate, for example, the latter two are, e.g., available in mixture as in Tinuvin® 292. Further commercially available products are, e.g., Tinuvin® 249 and Tinuvin® 123.

Amongst all of the above-mentioned light stabilizers those are particularly preferred, which do not negatively interfere with UV-curing of the UV curable coating compositions of the present invention in the UV-A range, i.e. in the wavelength range from 300 to 400 nm, preferably 315 nm to 385 nm.

### Dc) UV Absorbers

Suitable UV stabilizers comprise such as oxanilides, triazines and benzophenones. Most preferred amongst the triazines being hydroxyphenyl triazines (HTP), having a high absorbance in the UV-B region, such as the commercially available Tinuvin® 400. If UV absorbers are used herein, they are preferably used in combination with Db) one or more light stabilizers.

Amongst all of the above-mentioned UV absorbers those are particularly preferred, which do not negatively interfere with UV-curing of the UV curable coating compositions of the present invention in the UV-A range, i.e. in the wavelength range from 300 to 400 nm, preferably 315 nm to 385 nm.

Preferably component D consists of Da) one or more photoinitiators, Db) one or more light stabilizers and Dc) one or more UV absorbers.

### Component E

Optional component E encompasses as ingredients Ea) coating additives. These coating additives differ from those ingredients listed for component D or any other ingredients of component A, component B and component C. Component E may further comprise Eb) protic organic solvents; and/or Ec) colorants, such as dyes and/or pigments. Any further ingredients, which are not explicitly mention, may be subsumed under Ed) further ingredients. The amount of such Ed) further ingredients is preferably in the range from 0 to 5 wt.-%, more preferred in the range from 0 to 3 wt.-%, based on the total weight of the coating composition. Most preferred the coating composition does not contain such Ed) further ingredients.

### Ea) Coating Additives

Amongst the coating additives of component E, it may be distinguished between additives which affect the properties before cure and those after cure.

Additives affecting the properties of the coating composition before cure may be, e.g., substrate wetting additives, defoamers and deaerators, antioxidants and formulation stabilizers, rheological additives, and if pigments are present, also wetting and dispersing additives for pigments. Preferably, the UV curable coating compositions of the present invention do not contain pigments and do also not contain fillers, such as silicas.

Additives affecting the properties of the coating composition after cure may be, e.g., surface control additives, improving levelling, slip and scratch resistance properties, such as, e.g., waxes and polysiloxanes; matting agents; and agents to improve adhesion such as reactive adhesion promoters and thermoplastic co-binders.

### Eb) Protic Organic Solvents

As stated above, optional component E may also encompass protic organic solvents Eb) such as alcohols, which, if present at all, should be present in minor amounts which still allow for the total molar ratio of isocyanate reactive groups to free isocyanate groups in the UV curable coating composition being in the range from 0 to 1:5. If such protic organic solvents are present, they are typically introduced with commercially available additives such as the additives of component D or the additives of component E, wherein such additives are typically dissolved. The amount of protic solvents should be as low as possible, preferably 0 wt.-% based on the total weight of the coating composition. If present the amount should preferably be less than 10 wt.-% based on the total weight of the sum Ca) aprotic organic solvents and Eb) protic organic solvents.

### Ec) Colorants

The coating compositions according to the present invention may contain colorants. The colorants are typically selected from dyes (i.e., colorants which are soluble in the coating compositions) and much less preferred pigments (i.e., colorants which are insoluble in the coating compositions). Since the coating compositions of the present invention are preferably clearcoat compositions, pigments should preferably not be contained, but, if at all, in very low amounts (tinting amounts) or as transparent pigments, thus allowing light to transmit through the cured coating layer obtained from the coating compositions according to the present invention.

Preferably component E consists of Ea) one or more coating additives and/or Eb) one or more protic organic solvents and/or Ec) one or more colorants. Even more preferred component E consists of Ea) one or more coating additives and/or Eb) one or more protic organic solvents, and most preferred component E consists of Ea) one or more coating additives.

### Amounts of Components and Ingredients

Preferably the amount of the Aa) one or more resins as specified above is in the range from 15 to 45 wt.-%, more preferably 20 to 40 wt.-% and even more preferred from 25 to 35 wt.-%, based on the total weight of the coating composition according to the present invention.

Preferably the amount of the Ab) one or more UV reactive monomers as specified above is in the range from 5 to 20 wt.-%, more preferably 8 to 17 wt.-% and even more preferred from 10 to 15 wt.-%, based on the total weight of the coating composition according to the present invention.

Preferably, the weight ratio of the Aa) one or more resins as specified above to the Ab) one or more UV reactive monomers as specified above is in the range from 3.5:1 to 1.5:1, even more preferred 3:1 to 2:1.

Preferably the amount of the Ba) one or more isocyanate species as specified above is in the range from 10 to 35 wt.-%, more preferably 13 to 32 wt.-%, based on the total weight of the coating composition according to the present invention.

The combined amount of the Aa) one or more resins as specified above, the Ab) one or more UV reactive monomers as specified above and the Ba) one or more isocyanate species as specified above is preferably in the range from 45 to 80 wt.-%, more preferred from 50 to 75 wt.-% and most preferred from 55 to 70 wt.-%, based on the total weight of the coating composition.

Preferably the amount of the Ca) one or more aprotic organic solvents as specified above is in the range from 5 to 45 wt.-%, more preferably 10 to 40 wt.-%, even more preferred 15 to 35 wt.-% and most preferred 20 to 30 wt.-%, based on the total weight of the coating composition according to the present invention.

Preferably the amount of the Da) one or more photoinitiators as specified above is in the range from 3 to 15 wt.-%, more preferably 5 to 12 wt.-%, even more preferred 7 to 10 wt.-%, based on the total weight of the coating composition according to the present invention.

Preferably the amount of the Db) one or more light stabilizers as specified above is, if not zero, in the range from 0.1 to 2.0 wt.-%, more preferably 0.2 to 1.5 wt.-%, even more preferred 0.5 to 1.0 wt.-%, based on the total weight of the coating composition according to the present invention.

Preferably the amount of the Dc) one or more UV absorbers as specified above is, if not zero, in the range from 0.1 to 2.0 wt.-%, more preferably 0.2 to 1.5 wt.-%, even more preferred 0.5 to 1.0 wt.-%, based on the total weight of the coating composition according to the present invention.

The total solids content of the coating compositions according to the present invention is preferably in the range from 55 to 95 wt.-%, more preferred from 60 to 90 wt.-%, even more preferred 65 to 85 wt.-% and most preferred 70 to 80 wt.-%. The solids content being determined as specified in the experimental section of the specification.

Preferably the sum of components A, B, C, D and E adds to 100 wt.-%, i.e., the coating compositions according to the present invention consist of components A, B, C, D and E.

The total molar ratio of hydroxyl groups to free isocyanate groups in the UV curable coating composition is in the range from 0 to 1:5. While no hydroxyl groups are necessary or even desired for the UV curing mechanism of the coating compositions of the present invention, it is often a matter of practicability to employ resins Aa) which are completely free from hydroxyl groups, because such resins, due to their manufacture may often comprise minor amounts of hydroxyl groups. Thus, from the view of practicability a lower limit of the total molar ratio of hydroxyl groups to free isocyanate groups in the UV curable coating composition of the present invention is preferably 1:50, more preferred 1:30, such as 1:20. The upper limit of the total molar ratio of hydroxyl groups to free isocyanate groups in the UV curable coating composition of the present invention should not exceed 1:5 to avoid any significant curing based on urethane formation, which would limit the pot life of the composition. Thus, the upper limit of the total molar ratio of hydroxyl groups to free isocyanate groups in the UV curable coating composition of the present invention is preferably 1:6, more preferred 1:8 such as 1:10.

### Method of Preparing a Coating Composition According to the Present Invention

The method of preparing the coating compositions according to the present invention method comprising the steps of
a. mixing one or more of the Ca) aprotic organic solvents, which do not react with any of the other ingredients comprised in the coating composition of the present invention, with one or more of the other ingredients and/or components of coating composition of the present invention to form one or more dispersions or solutions of these ingredients and/or components;
b. subsequently mixing all dispersions and/or solutions obtained in step a. with any further ingredients and/or components of the coating composition of the present invention, except for component B or the dispersion or solution of component B with one or more of the Ca) aprotic organic solvents to thus form a master batch; and
c. subsequently mixing the master batch with component B and/or the dispersion or solution of component B with one or more of the Ca) aprotic organic solvents.

Although the coating compositions of the present invention can formally be regarded as two-component coating compositions, since their occurs some reaction between the NCO containing species Ba) and Bb) with the hydroxyl group containing species of Aa) (and maybe other OH containing species), their pot life after mixing all ingredients is rather long (up to two days) and the composition will not be fully cured without the application of UV radiation, particularly UV-A radiation.

Nevertheless, the mixing order is preferably the same as if a conventional two-pack composition is prepared. Inert solvents Ca) can actually be mixed with any other component or ingredient to dilute or dissolve the respective component or ingredient(s). Further all isocyanate reactive components and ingredients should preferably be mixed to form a master batch composition, which as such is storage stable. On the other hand, all components and ingredients containing species having free isocyanate groups should be mixed. Finally, in step c. the master batch is mixed with the isocyanate containing ingredients of component B. This should preferably be done short before the application, even though the pot life is long and thus the processing time is increased. Mixing step c. should preferably be carried out at ambient temperature, such as a temperature in the range from 18 to 30° C., preferably 20 to 25° C.

### Method of Preparing a Cured Coating Layer on a Surface of a Substrate

Further subject of the present invention is a method of preparing a cured coating layer at least partially on at least one surface of a substrate, wherein said method comprises the following steps:
i.) applying the coating composition according to the present invention at least partially onto at least one surface of an optionally pre-coated substrate to form a coating layer on the surface of the substrate; and subsequently
ii.) curing the coating layer obtained in step i.) by UV curing to form a cured coating layer on the surface of the substrate.

All preferred embodiments described herein above in connection with the coating composition according to the invention, are also preferred embodiments of the method according to the invention.

### Step i.)

The coating compositions may be applied one or more times by any of a very wide variety of spraying methods, such as gas-pressure, airless, air-mix or electrostatic spraying methods, for example, using one- or two-component spraying equipment, or else by spraying, troweling, knifecoating, brushing, roller coating, rolling, casting, laminating, injection backmolding, or coextruding. Methods operated with gas pressure may be carried out by means of air or else inert gas. Most preferred is the spray application, with particular preference for for handheld, pneumatic spray guns used in the air pressure range of 1.0-2.0 bar. The application of the coating composition of the present invention is preferably carried out at ambient temperature, such as a temperature in the range of 18° C. to 30° C., preferably in the range of 20 to 25° C.

### Blending Step Between Steps i.) and ii.)

In the present invention the coating composition preferably serves to build the uttermost coating layer on the substrate. In refinish coating application, it might in some instances be necessary to coat only a part of a precoated substrate with the UV curable coating composition according to the present invention. Thus, there might be areas on a coated substrate where the uttermost coating layer is an OEM coating layer, while at the area where a damaged surface has to be coated with the coating compositions according to the invention, the uttermost coating layer is the UV cured layer obtained in step ii.). To merge the two different coatings in the transition region of the two areas, typically so-called blenders or spot blenders are used. Thus, step i.) is preferably followed by a blending step.

The blenders are preferably UV-curable compositions (UV curable blender compositions), which may essentially contain the same types of ingredients as the coating compositions according to the present invention, but which preferably contain much higher amounts of Ca) aprotic organic solvents such as at least 60 wt.-%, more preferred at least 70 wt-%, even more preferred at least 80 wt.-% and most preferred at least 90 wt.-%, such as at least 95 to 99 wt.-% of Ca), based on the total weight of the UV-curable blender composition. Particularly preferred such blender composition comprises a component A, particularly Aa) and/or Ab); a component C, particularly Ca); at least one component D, particularly one or more photoinitiators Da); and preferably a component E, particularly one or more coating additives Ea), amongst which levelling agents and/or flow additives are preferred, all of the aforementioned components and ingredients as defined for the coating composition of the present invention. Component B may or may not be contained in the blender composition according to the present invention.

Typical blender compositions and their use are, e.g., described in WO 2007/027286 A1.

### Flash-Off Step Between Steps i.) and ii.)

Prior to curing, i.e., after step i.) and before step ii.), and before and/or after the optional blending step, it is preferred that there is given some time for the evaporation (“flash-off”) of the Ca) one or more aprotic solvents contained in the UV curable coating composition of the present invention and/or the solvents used in the blending step. Flash-off times are preferably in the range of 1 to 20 min, more preferred the range of 1 to 10 min, even more preferred in the range of 2 to 8 min, or 3 to 7 min. Flashing-off is preferably carried out at ambient temperature, such as a temperature in the range of 18° C. to 30° C., preferably in the range of 20 to 25° C.

### Step ii.)

UV-curing of the coating layer obtained in step i.) is preferably accomplished at ambient temperature, such as a temperature in the range of 18° C. to 30° C., such as preferably 20 to 25° C.

Curing can be accomplished by use of any UV curing equipment as known to one of skill in the art of UV curing coatings. Typical curing times are preferred to be in the range of 1 to 10 min, more preferred 2 to 8 min, even more preferred 3 to 7 min, such as 5 min±1 min. While curing in the UV-B and UV-C wavelength range is possible, for the UV curable coating compositions of the present invention, it is for safety reasons preferred to cure the coatings with light in the range of UV-A radiation (wavelength range: 315 to 400 nm; the wavelength subrange from >385 to 400 nm sometimes also being referred to as UV-Vis radiation, which herein is subsumed under the term UV-A radiation). UV lamps which are preferred are all types of Hg lamps with UV-A filter (particularly Hg—Fe lamps due to their higher UV-A output. However, it is also possible to use LED type lamps with wavelengths of UV light, e.g., being 365 nm, 385 nm or 395 nm. Generally, the lower the wavelength, the better the curing. Curing distances depend on lamp type and power and typically range from about 5 cm to about 50 cm.

Examples for suitable curing equipment are, e.g., a UVA-Hg Lamp of the type “1000 W Hedson-IRT UVA 1 Prepcure 4 Hg-lamp with UVA-filter” (exemplary conditions: 5 min curing time; 30 cm curing distance, 45 to 55 mW/cm² irradiation power, 2700 to 3300 mJ/cm² energy dose per minute); a 365-nm-LED (exemplary conditions: 5 min curing time; 10 to 40 cm curing distance, 40 mW/cm² irradiation power or higher (adjustment by distance or power of LED), 2400 mJ/cm² (or higher) energy dose per minute (adjustment by time or irradiation)); or a 395-nm-LED (exemplary conditions: 5 min curing time; 10 to 40 cm curing distance, 70 mW/cm² irradiation power or higher (adjustment by distance or power of LED), 4200 mJ/cm² (or higher) energy dose per minute (adjustment by time or irradiation)).

Preferably UV curing step ii) is carried out by the sole use of UV-A radiation. Since the coating compositions of the present invention are UV-A curable coating compositions, there is no need to apply the more aggressive shorter wavelengths radiation, such as UV-B and UV-C radiation, which is a particular advantage in refinish coating, because it requires less strict precautionary measures in handling the curing equipment in a refinish paint shop.

Preferred dry layer thicknesses of the UV-cured coating layer formed from the coating composition according to the invention are in the range from 10 to 100 μm, more preferred 20 to 80 μm, even more preferred, 30 to 70 μm, such as 40 to 60 μm.

Directly after curing, the cured layer is fully polishable.

### Pre-Coated or Uncoated Substrates

The pre-coated or not precoated, i.e., uncoated substrate as used in step i.), are preferably metallic substrates, plastic substrates, i.e., polymeric substrates, glass or ceramic. Preferably, the surface of the pre-coated or not precoated substrate comprises isocyanate reactive functional groups, more preferably hydroxyl groups.

The term “metallic substrate” encompasses any type of solid metal and alloys thereof. Particularly preferred metallic substrates are bare steel, galvanized steel, zinc, aluminum, magnesium, copper and alloys of the aforementioned metals. Most preferred substrates are steel, like cold rolled steel; galvanized steel, such as hot dip galvanized steel and electrogalvanized steel; and aluminum and its alloys.

If the substrate is a metallic substrate, such as an automotive body or part thereof, it is preferred that the substrate is pre-coated, preferably with a conversion coating layer as a pre-treatment, followed by an electrodeposition coating layer, one or more primer layers and/or one or more basecoat layers and even, in some cases already a clear coat layer.

Preferably, if the metallic substrate is coated with a conversion coating layer and an electrodeposition coating layer, a thus coated substrate is also pre-cured. Any following layers, such as one or more primer layers, one or more primer filler layers and one or more basecoat layers can be dried and/or cured separately.

Particularly in the refinishing practice, it is common to repair an OEM multi-layer coating. In such cases, due to the restriction in application techniques, the conversion coating layer and electrodeposition coating layer cannot be repaired by the originally used techniques. However, preferably a thermally curable two-component filler or a UV curable filler are employed to the substrate to form a filler layer, which is preferably cured before the application of one or more aqueous or solvent-borne, preferably aqueous basecoat compositions, preferably physically drying aqueous or solvent-borne basecoat compositions to obtain one or more basecoat layers; the basecoat layer(s) comprising on at least part of the surface isocyanate reactive functional groups, such as preferably hydroxyl groups. The isocyanate reactive functional groups, preferably hydroxyl groups contained on the surface of the basecoat layer are preferably isocyanate reactive functional groups, preferably hydroxyl groups of polymers contained in the basecoat compositions.

Thus, it is preferred that the pre-coated substrate as used in step i.) of the coating method of the present invention is a metallic substrate, which is at least pre-coated with a filler coating layer, preferably prepared from a two-component filler composition or a UV-curable filler composition, followed by at least one basecoat layer, preferably prepared from an aqueous or solvent-borne, preferably aqueous basecoat composition comprising polymers, the polymers comprising isocyanate reactive functional groups, preferably hydroxyl groups; and the basecoat composition preferably being a physically drying basecoat composition.

The substrate used can also be a plastic substrate, i.e., a polymeric substrate. Suitable polymers are poly(meth)acrylates including polymethyl (meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred. The plastic substrate can also be a composite substrate such as a fiber reinforced substrate containing e.g., glass fibers, carbon fibers or polymeric fibers such as polyamide fibers. The plastic substrate can also consist of multiple polymeric layers.

If the substrate is a plastic substrate, a glass substrate or ceramic substrate, it may also be a pre-coated substrate, which, e.g., bears a primer coating layer or adhesion promoting layer, or a basecoat layer as defined above, but does not have to.

### Use of the Coating Compositions

Yet another subject of the present invention is the use of the coating compositions of the invention in refinish coating applications as top coat, preferably as clear coat. Particularly preferred is the use in automotive refinish coating, most preferred as a clear coat on top of a basecoat layer preferably formed from an aqueous or solvent-borne, preferably aqueous basecoat composition, the basecoat composition preferably being a physically dried basecoat composition and preferably comprising polymers, the polymers comprising isocyanate reactive functional groups, preferably hydroxyl groups.

The examples which follow are intended to elucidate the invention, but not to restrict it to these examples.

### EXAMPLES

In the following, the present invention is described in greater detail using working examples. However, these working examples are intended to illustrate the invention and are not to be construed to limit the scope of the invention. Persons having ordinary skill in the art will appreciate that variations of the Examples are possible within the scope of the invention as defined solely by the claims. Hereinafter, the terms “parts” and “%” in the examples denote “parts by mass” and “% by weight”, respectively, unless otherwise indicated.

### Analytical Methods

### Gel Permeation Chromatography (GPC)

Determination of the Number-Average Molecular Weight Mₙ and Weight-Average Molecular Weight M_{w}

The number-average and weight-average molecular weights of the resins, oligomers and polymers as used in the present invention are determined by gel permeation chromatography (preferably using a polystyrene standard and tetrahydrofuran as diluent).

### Functionalities

GPC can also be used to conduct the determination of the average (meth)acrylic group functionality and average isocyanate group functionality of the components as, e.g., described in US 2020/0040123 A1 (paragraph [0050]). It is further possible to separate oligomers and/or polymers from each other by GPC and to determine for the thus obtained fractions the (meth)acrylic group functionality and isocyanate group functionality.

### Determination of the Hydroxyl Number

The hydroxyl number of the resins, oligomers and polymers as used in the present invention was determined in accordance with DIN EN ISO 4629-2 (December 2016).

### Determination of the Content of Free Isocyanate Groups (NCO Groups)

The content of NCO groups (in wt.-%) in the resins, oligomers and polymers as used in the present invention was determined by reacting the NCO groups with an excessive amount of dibutyl amine and titration of the non-reacted dibutyl amine with hydrochloric acid in accordance with DIN EN ISO 11909 (May 2007).

### Calculation of the Content of (Meth)acrylic Functional Groups

These groups are typically introduced into the Aa) one or more resins and Ba) one or more isocyanate species via monomers containing such (meth)acrylate groups, and the (meth)acrylic functionality is not consumed in such reaction. Thus the content of such groups can be calculated knowing the amount of such monomers introduced and knowing the total weight of the respective resin or species.

### Calculation of the Solids Content

The solids content (in weight-%) of each component, ingredient of a component or the coating composition itself was calculated by subtracting the amount(s) of the Ca) one or more aprotic organic solvents from the total weight of the respective component, ingredient of a component or the coating composition itself, dividing the resulting weight by the total weight of the respective component, ingredient of a component or the coating composition itself, and multiplying the thus obtained result by 100. The difference to 100 wt.-% is the volatile content of the sample, i.e., the amount of the Ca) one or more aprotic organic solvents contained in the sample.

### Testing Methods

All tests were carried out on samples, which were stored for 7 days at room temperature (23° C.) before starting the test, if not stated otherwise.

### Heat Resistance Test

The coated panels were subjected to heat (100° C.) for 60 min in an oven and evaluated visually for the occurrence of cracks.

### Gloss, Blistering and Adhesion Tests

Gloss and adhesion testing were done prior to and after constant climate testing of 240 h exposure duration. After constant climate testing, the formation of blistering was evaluated, as well. Constant climate testing was performed according to EN ISO 6270-2 (April 2018) using an exposure time of 240 h. The values given in table 2 are average values from two test panels for each measurement, unless indicated otherwise.

The gloss has been evaluated according to DIN EN 13523-2 (August 2014) under an angle of 20° at 10 different spots of one coated specimen prior and after constant climate testing. The average value was reported in the results with a precision of one digit.

The assessment of the blistering grade was made according to the density of the blisters and their size according to DIN EN ISO 4628-2 (July 2016). The assessment has been performed directly after constant climate testing and subsequent relaxation period in ambient conditions (22° C., 50% r.h.) for 1 h and 24 h.

Adhesion assessment was done by means of cross cut testing according to ISO 2409 using a multi-blade cutting tool to prepare a crosshatch pattern through the coating to the substrate. Detached parts of the coating were removed by brushing with a soft brush. Subsequently, an adhesive tape was applied and removed over the cross hatch to remove all detached parts of the coating. Classification has been done according to ISO 2409, Table 1. Cross hatch testing has been performed before as well as after constant climate control testing. After climate control testing cross hatch testing has been performed after a recovery time of 1 h and 24 h. The cross hatch has been covered by an adhesive tape during climate control testing to avoid corrosion in the prepared cross hatch.

### Weather-Ometer® CAM 180 Test

The cured coated steel panels were exposed to UV radiation and wet-dry cycling in the so-called CAM 180 test (according to SAE J2527_Sep17). The coatings were examined for the occurrence of cracks. The time at which first cracks were observed was determined. The minimum time without observing cracks as required by industrial standards is 3000 h.

### Working and Comparative Examples

For the Weather-Ometer® CAM 180 test Gardobond 26S/GN D6800/OG from Chemetall coated with CathoGuard® 800 (size: 72.5×72.5 mm) were used, while for the other tests Gardobond 26S/6800/OC coated with CathoGuard® 580 (size: 105×190 mm) were used. Both types of panels were wiped with isopropanol and coated as follows.

First, a filler (Glasurit® Primer Filler Pro 285-270, grey; Glasurit® Filler Hardener 929-58 and Glasurit® Reducer 352-91) was applied in two spray coats (SATA Jet 4000 Spray gun; nozzle: 1.4; air pressure: 2 bar), flashed-off for 10 min at room temperature, cured for 45 min at 60° C. to form a filler layer having a dry film thickness of 90±10 μm. The thus cured panels were sanded with P400 and wiped with Glasurit® Cleaner 700-1.

Subsequently, a basecoat, being Glasurit® Line 100, was applied in the same way and with the same equipment as described for the filler. After 2 h of drying time at room temperature, the dry film thickness was 12.5±2.5 μm.

Finally, onto the thus prepared pre-coated panels a comparative clearcoat composition (Comparative Example, Table 1) and inventive clearcoat compositions (Examples 1 to 3, Table 1) applied in the same way and with the same equipment as described for the filler, followed by a 5 min flash-off at room temperature to obtain the respective clearcoat layer. Subsequently, the thus obtained clearcoat layer was radiation-cured for 5 min with Hedson-IRT UVA 1 Prepcure 4 Lamp at distance of 30 cm from the light source with UV-A light only (100%) to obtain a cured clearcoat layer having a dry layer thickness of approx. 50±10 μm.

TABLE 1
Clearcoat Compositions

| | | Comparative | Example | Example | Example |
|---|---|---|---|---|---|
| Component/Ingredient | | Example | 1 | 2 | 3 |
| Aa | Aliphatic urethane-modified | 21.00 | 21.00 | 21.00 | 21.00 |
| | acrylic resin 1¹ | | | | |
| Aa | Aliphatic urethane acrylate 2¹ | 3.50 | 3.50 | 3.50 | 3.50 |
| Ab | hexanediol diacrylate | 9.00 | 9.00 | 9.00 | 9.00 |
| Ab | trimethylolpropane formal | 1.50 | 1.50 | 1.50 | 1.50 |
| | monoacrylate | | | | |
| Ca | methylisobutylketone | 22.00 | 22.00 | 22.00 | 22.00 |
| Da | Photoinitiator³ | 7.40 | 7.40 | 7.40 | 7.40 |
| Db | hindered amine light stabilizer⁴ | 0.70 | 0.70 | 0.70 | 0.70 |
| Dc | UV absorber (UV-B absorber)⁵ | 0.68 | 0.68 | 0.68 | 0.68 |
| Ea | additive for reduction of surface | 0.10 | 0.10 | 0.10 | 0.10 |
| | tension and slip⁶ | | | | |
| Eb | 1-methoxy-2-propanol | 0.12 | 0.12 | 0.12 | 0.12 |
| Ba | NCO and acrylate functional | 0.00 | 10.00 | 20.00 | 30.00 |
| | allophanate⁷ | | | | |

¹(meth)acrylic functionality: 2.4; hydroxyl number: 11 mg KOH/g
² (meth)acrylic functionality: 2.8, hydroxyl number: 6 mg KOH/g
³photoinitiator mixture of two phenylglyoxalates
⁴bis(1,2,2,6,6-pentamethyl-4-piperidyl) sebacate and methyl-(1,2,2,6,6-pentamethyl-4-piperidyl) sebacate
⁵hydroxyphenyltriazine type
⁶polyether-modified polydimethylsiloxane
⁷(meth)acrylic functionality: 2.0; NCO functionality: 2.0; NCO content: 14-15 wt.-%

### Results

Compared to the Comparative Example, the Examples according to the present invention (Examples 1 to 3) showed less or no cracks after the heat resistance test and also better results in the cross-cut testing, thus confirming the better adherence to the subjacent basecoat layer obtained from an aqueous physically drying basecoat composition. The number and size of blisters remain unchanged after 24 h after exposure, which is the relevant time span which ensures the sufficient drying of the samples after the test. For all inventive Examples gloss was improved 24 h after exposure to constant climate testing. The rather severe WOM CAM 180 test showed significantly increased weathering resistance, determined in hours after which first cracks are observed, compared to the Comparative Example.

TABLE 2
Test Results of Multilayer Testing

| | | Comparative | Example | Example | Example |
|---|---|---|---|---|---|
| Component/Ingredient | | Example | 1 | 2 | 3 |
| Heat Resistance Test | | Many long cracks | Few cracks | No cracks | No cracks |
| Cross | before exposure | 1 | 0.5 | 0 | 1 |
| Cut | 24 h after exposure | 3 | 2 | 1 | 1 |
| Blisters | 1 h after exposure | 0 | 1 | 0 | 0 |
| (number) | 24 h after exposure | 0 | 0 | 0 | 0 |
| Blisters | 1 h after exposure | 0 | 1.5 | 0 | 0 |
| (size) | 24 h after exposure | 0 | 0 | 0 | 0 |
| Gloss | before exposure | 90.0 | 90.5 | 90.5 | 89.5 |
| | directly after | 84.5 | 84.5 | 88.0 | 84.0 |
| | exposure | | | | |
| | 24 h after exposure | 84.5 | 86.5 | 89.5 | 88.0 |
| WOM | Panel 1 | 1000 | 3000 | 4500 | 5000¹ |
| CAM | Panel 2 | 2500 | 4500 | 4500 | 5000¹ |
| 180 | Panel 3 | 1000 | 2250 | 4500 | 4500 |
| (hours) | | | | | |

¹no cracks

1. A UV curable coating composition comprising
A) a component A, comprising
Aa) one or more resins
i. each of these resins having a hydroxyl number in a range of from 0 to 25 mg KOH/g;
ii. each of these resins having a (meth)acrylic group functionality of at least 1.5; and
iii. a total of these resins having in sum on average a (meth)acrylic group functionality of from 2.0 to 4.0;
Ab) one or more UV reactive monomers comprising one or two (meth)acrylic groups;
B) a component B, comprising
Ba) one or more isocyanate species containing one or more groups selected from the group consisting of allophanate groups, biuret groups, uretdione groups, urethane groups, iminooxadiazindione groups and isocyanurate groups, each isocyanate comprising on average at least one isocyanate group and at least one (meth)acrylate group;
C) a component C, comprising
Ca) one or more aprotic organic solvents, which do not react with any of the other ingredients comprised in the UV curable coating composition; and
D) a component D, comprising
Da) one or more photoinitiators; and at least one of Db) and/or Dc)
Db) being one or more light stabilizers; and
Dc) being one or more UV absorbers;
wherein the total molar ratio of hydroxyl groups to free isocyanate groups in the UV curable coating composition is in a range from 0 to 1:5.

2. The curable coating composition according to claim 1, wherein the component B further comprises
Bb) one or more polyisocyanates which do not contain (meth)acrylic groups.

3. The curable coating composition according to claim 1, wherein the Aa) one or more resins are selected from the group consisting of aliphatic urethane (meth)acrylates, aliphatic polyester (meth)acrylates and aliphatic urethane group containing (meth)acrylic resins.

4. The curable coating composition according to claim 1, wherein the Ab) one or more UV reactive monomers are aliphatic UV reactive monomers.

5. The curable coating composition according to claim 1, wherein the Ba) one or more isocyanate species are aliphatic and contain allophanate groups.

6. The curable coating composition according to claim 5, wherein the one or more isocyanate species are made by reacting one or more aliphatic diisocyanates with one or more hydroxyalkyl (meth)acrylates.

7. The curable coating composition according to claim 5, wherein the aliphatic allophanate has the following formula (I) 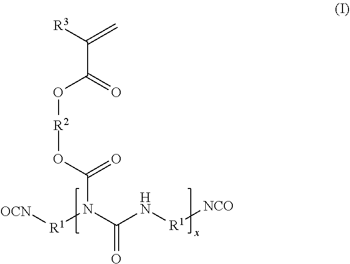
wherein
R¹ is a divalent linear or branched or cyclic alkylene radical which has from 2 to 20 carbon atoms
R² is a divalent branched or linear alkylene radical which has from 2 to 12 carbon atoms;
R³ is H or methyl; and
x is a positive number being on average more than 1 up to 4.

8. The curable coating composition according to claim 1, wherein it further comprises a component E, which comprises Ea) one or more coating additives and/or Eb) one or more protic organic solvents and/or Ec) one or more colorants.

9. The curable coating composition according to claim 1, that wherein the coating composition is a UV-A curable coating composition.

10. The curable coating composition according to claim 1, comprising:
Aa) resins in a range of from 15 to 45 wt.-%;
Ab) UV reactive monomers in a range of from 5 to 20 wt.-%;
Ba) isocyanate species in a range of from 10 to 35 wt.-%;
Ca) aprotic organic solvents in a range of from 5 to 45 wt.-%;
Da) photoinitiators in a range of from 3 to 15 wt.-%;
Db) optionally light stabilizers in a range of from 0.1 to 2.0 wt.-%; and
Dc) optionally UV absorbers, if present, is in a range of from 0.1 to 2.0 wt.-%;
wherein the ranges are based on the total weight of the coating composition.

11. A method of preparing the UV curable coating compositions according to claim 1 comprising the steps of
a. mixing one or more of the Ca) aprotic organic solvents, which do not react with any of the other ingredients comprised in the coating composition, with one or more of the other ingredients and/or components of coating composition to form one or more dispersions or solutions of these ingredients and/or components;
b. subsequently mixing all dispersions and/or solutions obtained in step a. with any further ingredients and/or components of the coating composition, except for component B or the dispersion or solution of component B with one or more of the Ca) aprotic organic solvents to thus form a master batch; and
c. subsequently mixing the master batch with component B and/or the dispersion or solution of component B with one or more of the Ca) aprotic organic solvents.

12. A method of preparing a cured coating layer at least partially on at least one surface of a substrate, wherein said method comprises the following steps:
i.) applying a UV curable coating composition according to claim 1 at least partially onto at least one surface of an optionally pre-coated substrate to form a coating layer on the surface of the substrate; and subsequently
ii.) curing the coating layer obtained in step i.) by UV curing to form a cured coating layer on the surface of the substrate.

13. The method according to claim 12, wherein the substrate is a pre-coated substrate comprising a basecoat layer.

14. A method of using the coating composition according to claim 1, the method comprising using the coating composition in refinish coating applications as a top coat coating composition.

15. The method according to claim 14, wherein the refinish coating is automotive refinish coating and the coating composition is a clear coat composition.
